(19) United States
(12) Patent Application Publication
(10) Pub. No.: US 2023/0079398 A1
(43) Pub. Date: Mar. 16, 2023

(54) TANK CONTAINER FOR STORING GASES AND METHOD FOR MANUFACTURING SAID TANK CONTAINER

(71) Applicant: Robert Bosch GmbH, Stuttgart (DE)

(72) Inventors: Sebastian Bucher, Sachsenheim (DE); Benjamin Seitz, Calw Ernstmuehl (DE); Lukas Loeber, Ludwigsburg (DE); Friedrich Muehleder, Muehlacker (DE)

(21) Appl. No.: 17/801,838

(22) PCT Filed: Feb. 17, 2021
(86) PCT No.: PCT/EP2021/053836

§ 371 Date: Aug. 24, 2022

(30) Foreign Application Priority Data
Mar. 11, 2020 (DE) 10 2020 203 128.2

(51) Int. Cl. F17C 1/14

(52) U.S. Cl. CPC F17C 1/14; F17C 2221/012; F17C 2201/056; F17C 2203/012; F17C 2201/0109; F17C 2203/0639; F17C 2209/232; F17C 2209/2181; F17C 2203/0617; F17C 2209/221; F17C 2260/011; F17C 2260/012; F17C 2270/0178; F17C 2260/013

(57) ABSTRACT

A tank container for storing gases, in particular for storing hydrogen in a motor vehicle. The tank container includes a main body which is preferably tubular, and comprises reinforcement elements which are arranged on a wall of the main body and are produced using an additive manufacturing process.

### FIELD

The present invention relates to a tank container for storing gases, in particular for storing hydrogen in a motor vehicle. The present invention also relates to a method for manufacturing a tank container according to the present invention.

### BACKGROUND INFORMATION

German Patent Application No. DE 10 2014 107 316 A1 describes a tank container for storing gases. The tank container described in this patent application is used in wing or fuselage structures of aircraft and is characterized in that reinforcement elements formed in an additive manufacturing process can be formed on a main body. The patent application also states that the main body is also produced in an additive manufacturing process. When used in aircraft, it is usual and necessary to keep the weight of the tank container as low as possible, and so the tank container described in the patent application may typically be made of aluminum, but no information on the choice of material is disclosed in the patent application.

### SUMMARY

A tank container for storing gases according to the present invention may be advantageous in that it allows the tank container to be manufactured in a particularly simple and economically advantageous manner. This also includes a relatively short production time for the container. According to the present invention, the main body and the reinforcement elements for the main body are produced from materials that are as inexpensive as possible and yet still relatively strong, and the main body is designed in such a way that it can be produced as simply as possible, with a short production time and at low cost. According to an example embodiment of the present invention, the tank container is designed in such a way that both the main body and the reinforcement elements are made from metal, in particular at least substantially made from steel, and the main body is designed as a component manufactured in a forming process or as a welded structure, on the wall of which the reinforcement elements are directly applied. A tank container designed in this way makes it possible to design the main body in a relatively simple manner, for example in the form of a welded structure, and then to (directly) apply the reinforcement elements on the wall of the main body in order to increase the strength of the main body.

Advantageous developments of the tank container according to the present invention are disclosed herein.

There are different possibilities with regard to the arrangement of the reinforcement elements. According to an example embodiment of the present invention, the reinforcement elements are arranged in the region of an outer wall of the main body. This is advantageous because it does not reduce the volume of the main body for receiving gas, and, by means of the reinforcement elements that are arranged on the outside, the main body, which is under (relatively high) pressure, can be easily stiffened or reinforced by the reinforcement elements.

The arrangement or formation of the reinforcement elements on the outer wall of the main body also offers the possibility of forming them from a metal that does not have to be hydrogen-resistant, since the reinforcement elements are not directly operatively connected to or in direct contact with the hydrogen, in contrast with an arrangement of the reinforcement elements on the inner wall of the main body.

Alternatively or additionally, however, it is also possible for the reinforcement elements to be arranged in the region of an inner wall of the main body. This is advantageous, for example, if the inner region or the interior of the main body is to be subdivided into different sections or portions, so that the reinforcement elements then simultaneously form a corresponding partition wall or the like. In this case, both the main body and the reinforcement elements must consist of a hydrogen-resistant metal.

With a view to a design of the reinforcement elements that is as simple and weight-optimized as possible, these are preferably rib-shaped.

In a development of a rib-shaped design of the reinforcement elements according to the present invention, it is possible, both for weight optimization and for strength optimization, for the width and/or height of the reinforcement elements to be different or vary in the region of a reinforcement element.

An arrangement of the reinforcement elements in which they are arranged on the main body in the manner of a net or spiral has proven to be particularly advantageous, according to an example embodiment of the present invention. In this case, the arrangement in the manner of a net or spiral can take place, in the case of a cylindrical main body, for example at an oblique angle to a longitudinal axis of the main body.

Furthermore, the present invention comprises a method for manufacturing a tank container according to the present invention as described above, wherein the main body and the reinforcement elements are manufactured by different manufacturing methods, and wherein the reinforcement elements are directly produced on a wall of the main body in an additive manufacturing process after the main body has been fully manufactured.

With regard to the additive manufacturing process used for the formation of the reinforcement elements, there are also multiple possibilities, whereby in a first preferred embodiment the reinforcement elements are produced in a DMD (direct metal deposition) method, and in another preferred embodiment in an EBAM (electron beam additive manufacturing) method. If one of the two methods mentioned does not apply, it is of course also within the scope of the present invention to use another conventional method for the additive manufacture of the reinforcement elements.

If the reinforcement elements have to be arranged or formed on an inner wall or in the interior of the main body, according to an example embodiment of the present invention, it has proven to be advantageous if they are produced on the inner wall by means of a lance-like device, wherein the lance-like device projects into an opening of the main body.

Further advantages, features and details of the present invention can be found in the following description of preferred embodiments of the present invention and with reference to the figures.

### BRIEF DESCRIPTION OF THE DRAWINGS

FIG. 1 is a simplified longitudinal section of a tank container for storing gas, in particular for storing hydrogen in a motor vehicle, during production, according to an example embodiment of the present invention.

FIG. 2 is an external view of the tank container according to FIG. 1.

FIG. 3 is a partially sectional side view of a rib-like reinforcement element which is applied to a wall of the tank container according to FIG. 1 or 2.

FIG. 4 is a view in the direction of arrow IV of FIG. 3.

### DETAILED DESCRIPTION OF EXAMPLE EMBODIMENTS

Identical elements or elements which have the same function are provided with the same reference signs in the figures.

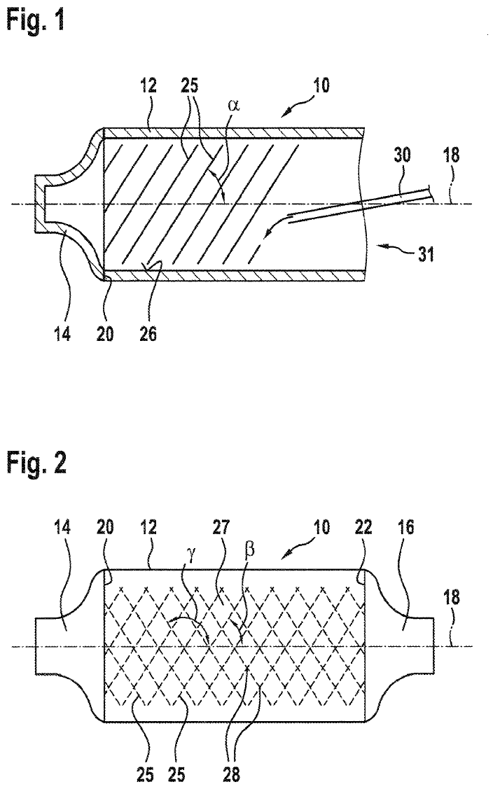

FIGS. 1 and 2 show a tank container 10 for storing gas, in particular for storing hydrogen, in a motor vehicle (not shown). The tank container 10 has a tubular main body 12 that is designed to be cylindrical, for example, and which is closed at each end by a cover 14, 16. The main body 12 can either be produced by a forming process, for example by means of extrusion or the like, or for example from a planar blank that is shaped or bent to form a circular cross section with a longitudinal weld seam (not shown). The main body 12 can also consist, for example, of two half-shell elements that are welded to one another at their longitudinal edges.

The covers 14, 16 can also be designed in different ways, the covers 14, 16 and the main body 12 preferably being connected by a weld seam 20, 22 that extends radially around a longitudinal axis 18 of the main body 12. In particular, the main body 12 and the two covers 14, 16 consist of a steel material, optionally with alloying additions.

In addition, it is noted that the shape of the main body 12 is not intended to be limited to circular cross sections, but can also be designed to be oval. In this case, the cross section of the main body 12 or the shape of the tank container 10 is typically adapted to the installation conditions of the tank container 10 in the vehicle in order to allow maximum space utilization or a maximum tank volume.

In order to bring about a stiffening of the tank container 10 or a minimization of the wall thickness of the main body 12 and optionally of the covers 14, 16, in particular as a result of the gas stored under relatively high pressure in the tank container 10, the tank container 10, in particular its main body 12, is equipped, at least in regions, with reinforcement elements 25.

The reinforcement elements 25 can in this case be provided in the region of the inner wall 26 of the main body 12 and in the region of the outer wall 27 of the main body 12. For example, it can be seen in FIG. 1 that the reinforcement elements 25 arranged on the inner wall 26 are arranged at an angle α with respect to the longitudinal axis 18 and are formed in a spiral-shaped or annular manner.

In contrast, the reinforcement elements 25 provided on the outer wall 27 of the main body 12 are designed, also purely by way of example, in the manner of a net; i.e., the individual reinforcement elements 25 have common points of intersection 28. The reinforcement elements 25 extend at an angle β with respect to the longitudinal axis 18 of the main body 12.

It may be important that the reinforcement elements 25 are produced directly on the inner wall 26 or the outer wall 27 of the main body 12 in an additive manufacturing method. For this purpose, material application preferably either takes place by a DMD (direct metal deposition) method or an EBAM (electron beam additive manufacturing) method.

In the exemplary embodiment shown in FIG. 1, the reinforcement elements 25 are produced on the inner wall 26 when the cover 14 is already welded or connected to the main body 12 but the other cover 16 is not yet connected to the main body 12. Of course, for better accessibility into the interior of the main body 12, it is also possible to produce the reinforcement elements 25 on the inner wall 26 in a state in which the two covers 14 and 16 are not yet connected to the main body 12. In order to form the reinforcement elements 25, in particular in the region of the inner wall 26, a lance-like device 30 is preferably used, by means of which accessibility into the cross-sectional region of the main body 12 is made possible in the region of an end opening 31 of the main body 12.

The basic material of the reinforcement elements 25 also consists of steel, preferably of the same basic material as the main body 12.

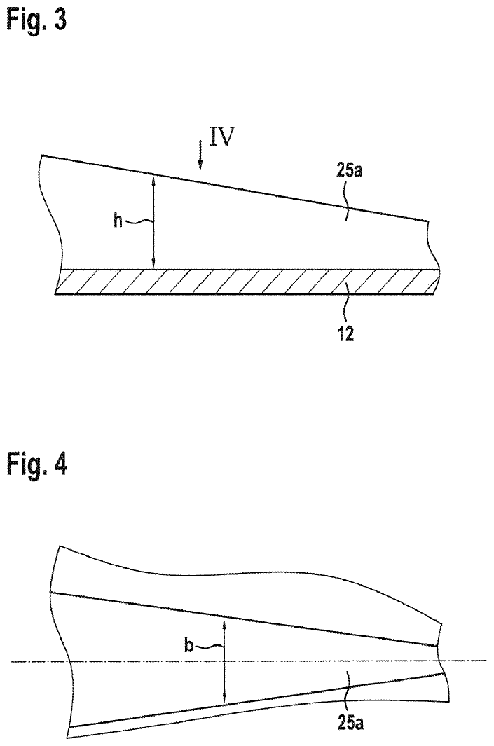

FIGS. 3 and 4 show, with reference to a reinforcement element 25a, that the height h can be variable, for example linearly increases or decreases, in a longitudinal extension of the reinforcement element 25a. In accordance with FIG. 4, it can also be seen that the width b of the reinforcement element 25a can also be variable in the longitudinal extension, for example linearly decreases or increases. The differing geometry of the reinforcement elements 25a on the main body 12 makes it possible, in the context of a uniform strength or a required, locally differing strength of the main body 12, to save material and thus weight for the reinforcement elements 25, 25a or to allow faster production. Furthermore, a locally adapted strength can also be achieved by corresponding control of the production process or by a different material composition of the reinforcement elements 25, 25a.

1-11. (canceled)

12. A tank container for storing hydrogen in a motor vehicle, comprising:
a main body; and
reinforcement elements which are arranged on a wall of the main body and are produced using an additive manufacturing process;
wherein both the main body and the reinforcement elements are made from metal, and the main body is a component manufactured in a forming process or as a welded structure, on the wall of which the reinforcement elements are directly applied.

13. The tank container as recited in claim 12, wherein the main body is tubular.

14. The tank container as recited in claim 12, wherein the main body and the reinforcement elements are made at least substantially from steel

15. The tank container according to claim 12, wherein the wall on which the reinforcement elements are arranged forms an outer wall of the main body.

16. The tank container according to claim 12, wherein the metal of the main body is hydrogen-resistant, and the reinforcement elements are made of a non-hydrogen-resistant metal.

17. The tank container according to claim 12, wherein the wall on which the reinforcement elements are arranged forms an inner wall of the main body.

18. The tank container according to claim 12, wherein the reinforcement elements are rib-shaped.

19. The tank container according to claim 18, wherein a width and/or height of each of the reinforcement elements is different or varies in a region of the reinforcement element.

20. The tank container according to claim 12, wherein the reinforcement elements are arranged on the main body in the manner of a net or spiral.

21. A method for manufacturing a tank container for storing hydrogen in a motor vehicle, the method comprising:
manufacturing a main body and reinforcement elements by different manufacturing methods, the reinforcement elements being directly produced on a wall of the main body in an additive manufacturing process after the main body has been manufactured.

22. The method according to claim 21, wherein the reinforcement elements are produced in a direct metal deposition (DMD) method.

23. The method according to claim 21, wherein the reinforcement elements are produced in an electron beam additive manufacturing (EBAM) method.

24. The method according to claim 21, wherein the reinforcement elements are formed on an inner wall of the main body, a material for the reinforcement elements being produced on the inner wall by using a lance-like device which projects into an opening of the main body.
